(19) United States
(12) Patent Application Publication
(10) Pub. No.: US 2025/0093275 A1
(43) Pub. Date: Mar. 20, 2025

(54) MULTI-CAMERA SYNCHRONIZATION FOR INSPECTION SYSTEMS

(71) Applicant: VIRTEK VISION INTERNATIONAL INC., Waterloo (CA)

(72) Inventors: Ahmed Elhossini, Waterloo (CA); Mehrdad Bakhtiari, Kitchener (CA); Daljit Josh, Guelph (CA)

(73) Assignee: VIRTEK VISION INTERNATIONAL INC., Waterloo (CA)

(21) Appl. No.: 18/890,360

(22) Filed: Sep. 19, 2024

Related U.S. Application Data
(60) Provisional application No. 63/539,479, filed on Sep. 20, 2023.

(51) Int. Cl. G01N 21/88

(52) U.S. Cl. CPC G01N 21/8806; G01N 21/8851; G01N 2021/8838; G01N 2201/0484

(57) ABSTRACT

An inspection system includes an inspection controller that is electronically connected to a first camera and a second camera, each of which is aligned to cooperatively examine a surface of an object. The first camera defines the first field of view of the object and the second camera defines a second field of view of the object with the first field of view and the second field of view encompassing different areas of the surface of the object. The first camera includes a first clock, and the second camera includes a second clock. The first camera generates a plurality of first images of the object defined by the first field of view and the second camera generates a plurality of second images of the object defined by the second field of view. An inspection controller is programed to synchronize one of the plurality of first images with one of the plurality of second images as defined by a first time stamp assigned by the first clock to one of the plurality of first images matching a second time stamp assigned by the second clock to one of the plurality of second images.

### PRIOR APPLICATIONS

The present application claims priority to U.S. Provisional Patent App. No. 63/539,479 filed on Sep. 20, 2023, the contents of which are included herein by reference.

### TECHNICAL FIELD

Invention relates generally toward a camera inspection system of a work surface. More specifically, the present invention relates toward synchronization of camera inspection when a plurality of cameras are required to inspect a large work surface.

### BACKGROUND

To reduce human error associated with inspection of work surfaces upon which assembly tasks have been performed implementation of electronic inspection is becoming more prevalent. One such inspection system makes use of camera based inspection with artificial intelligence assist such as disclosed in co-pending U.S. patent application Ser. No. 18/133,739 filed on Apr. 12, 2023, the contents of which are included herein by reference.

Attempts have been made to implement camera inspection of very large work surfaces such as, for example aerospace components, turbine blades, manufactured trusses and the like. However, when either highly specific inspection is required, or very large work surfaces require inspection, multi camera based inspection systems are often required.

While these systems are required to achieve high quality repeatable inspection results, oftentimes variation in imaging becomes problematic, particularly when generation a composite image is desirable. For example, synchronization of the imaging is required when very slight movement of the inspection surface occurs while imaging is performed. Thus, synchronization of multiple images is desirable to verify that high quality repeatable results are achieved. Therefore, it would be desirable to implement a system that synchronizes camera imaging even to within fractions of a second.

### SUMMARY

An inspection system includes an inspection controller, a first camera and a second camera. The first camera and the second camera are aligned to cooperatively image a surface of an object. The first camera defines a first field of view of the object and the second camera defines a second field of view of the object with the first field of view and the second field of view encompassing distinct areas of the surface of the object. The first camera includes a first clock, and the second camera includes a second clock. The first camera generates a plurality of first images of the object defined by the first field of view and the second camera generates a plurality of second images of the object defined by the second field of view. The inspection controller is programed to synchronize one of the plurality of first images generated by the first camera with one of the plurality of second images generated by the second camera when a first time stamp assigned by the first clock to one of the plurality of first images matches a second time stamp assigned by the second clock to one of the plurality of second images.

Time synchronization of images of different fields of view of an object generated by first and second cameras provides necessary accuracy for inspection of surfaces that require a plurality of cameras. Assigning a clock to each camera and synchronizing the clocks provides the ability to generate a composite image of a surface of an object that is accurate and compiled at a same time. Synchronization in this manner eliminates inconsistencies in composite images that are caused when the object is prone to movement either by intent or by dynamic movement.

### BRIEF DESCRIPTION OF THE DRAWINGS

Other advantages of the present invention will be readily appreciated as the same becomes better understood by reference to the following detailed description, when considered in connection with the accompanying drawing, wherein:

FIG. 1 show a schematic of the system of the present invention with respect to a stationary object;

FIG. 2 shows a schematic of the system of the present invention with respect to a moving object representing initial synchronization; and

FIG. 3 shows a schematic of estimation of velocity vector during an object inspection of an object.

### DETAILED DESCRIPTION

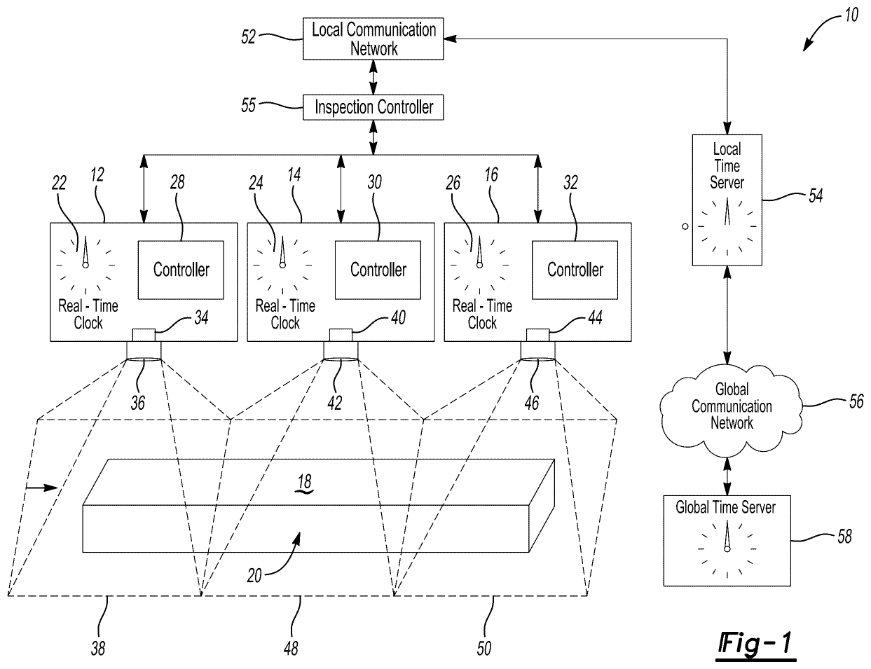

Referring to FIG. 1, a schematic of the inspection system is generally shown at 10. The system 10 includes a plurality of cameras, and in this embodiment, a first camera 12, a second camera 14, and a third camera 16 used to inspect a surface 18 of an object 20. For brevity, the description set forth below will reference the first camera 12, the second camera 14, and the third camera 16. However, any number of cameras may be implemented to perform the desired inspection of the surface 18 of the object 20. A large number of cameras may be selected if the surface 18 is expansive such as, for example, a surface of an aerospace fuselage or wing, wind turbine blades, and the like. The first camera 12 includes a first clock 22, the second camera 14 includes a second clock 24, and the third camera 16 includes a third clock 26. Likewise, the first camera 12 includes a first controller 28, the second camera 14 includes a second controller 30 and the third camera 16 includes a third controller 32.

The first camera 12 includes an imaging sensor 34 and a lens 36 that focuses a first field of view (FOV) 38 on the surface 18 of the object 20. Likewise, the second camera 14 includes a second imaging sensor 40 and second lens 42 while the third camera 16 includes a third sensor 44 and a third lens 46. Therefore, the second camera 14 is configured to view a second FOV 48 and the third camera is configured to view a third FOV 50. The configuration of each of the lenses 36, 42, 46 each define the breadth of the FOV 38, 48, 50.

Each of the cameras 12, 14, 16 generate images of distinct areas on the surface 18 and adjacent to the surface 18 of the object 20. In one embodiment, the FOV's 38, 48, 50 overlap on the surface 18 of the object 20. Alternatively, none or some of the FOV's 38, 48, 50 overlap. However, the entirety of the inspection surface 18 is desirably subject to an FOV from at least one of the cameras 12, 14, 16.

The sensors 34, 40, 44 take the form of conventional imaging sensors that include, but are not limited to, CCD and CMOS type sensors. These types of sensors are included in the term sensor array as used throughout this application. The lens 36, 42, 46 associated with each sensor 34, 40, 44 focuses a generated image and defines the size of the FOV 38, 48, 50. Therefore, the interaction between the lens 36, 42, 46 and its corresponding sensor array 34, 40, 44 is conventional and should be understood to those of skill in the art.

Each controller 28, 30, 32 is electronically connected via a local communication network 52 to a local time server 54. An inspection controller 55 administers communication between each controller 28, 30, 32 and the local time server 54. Further, the inspection controller 28, 30, 32 processes the data generated by each camera 12, 14, 16 as will become more evident hereinbelow. The electronic connection established by the communication network 52 may be achieved through hardwire or through Wi-Fi, Bluetooth, or cellular connection. Therefore, complexity of installation of the cameras 12, 14, 16 into a facility may be simplified through elimination of hard wiring. The local time server 54 interconnects to a global communication network 56 such as, for example, the Internet, for communicating with a global time server 58.

The clocks 22, 24, 26 set forth above are further defined as “real time clocks” that measure time relative to a specific point in time. Thus, each clock is synchronized through the global time server 58 with, for example, the digital epoch of Jan. 1, 1970. Each local controller 28, 30, 32 provides an unique reference point to perform synchronization of the cameras 12, 14, 16, and more importantly, the clocks 22, 24, 26. To maintain synchronization, each clock 22, 24, 26 connects via controller 28, 30, 32 to the global time server 58 periodically using individualized, and specific protocol for calculating time drift of each clock 22, 24, 26 relative to the global time server 58. If every camera 12, 14, 16 included in the system 10 uses the same global time server 58, each real time clock 22, 24, 26 defines an exact and common time frame.

The following explains a process by which synchronization of each clock 22, 24, 26 and therefore each camera 12, 14, 16 is achieved. By way of the global communication network 56, each local controller 28, 30, 32 performs time synchronization with the global time server 58. This synchronization may be performed at any the time global connection is active between the local time server 54 and the global time server 58, including short or long intervals. Each of the cameras 12, 14, 16 use the local communication network 52 to synchronize with the local time server 54 at shorter time intervals than the synchronization interval between the local time server 54 and the global time server 58. Because the local communication network 52 is always active, the cameras 12, 14, 16 are capable of performing this synchronization at any moment of time, even at which time imaging of the FOV 38, 48, 50 is performed. Thus, real time synchronization of the clocks 22, 24, 26 disposed in each camera 12, 14, 16 respectively, verify that images are made at the same time using the clock resolution that is typically within microseconds of accuracy.

During the inspection process, each camera 12, 14, 16 captures images (frames) of the surface 18 of the object being inspected. As explained hereinabove, each sensor 34, 40, 44 interacts with its related lens 36, 42, 46 to generate an image of the camera's 12, 14, 16 corresponding FOV 38, 48, 50. Thus, each camera 12, 14, 16 provides a frame that includes an image of the surface 18 that is within the FOV 38, 48, 50 respectively. This arrangement enables a plurality of images generated by each camera 12, 14, 16 to be synchronized at an exact moment of time.

When pre-determining a moment of time at which a synchronized image is generated by the cameras 12, 14, 16 continuous frame captures are made at specific time intervals and the moment of time in which the images captured by any given camera is matched with the other cameras. Each camera 12, 14, 16 constitutes an independent imaging system. Thus, the instance of time at which any of the sensors begins to capture a frame is different from one camera to the other cameras. Furthermore, the time required to transfer the image data from any sensor 34, 40, 44 to the controller 28, 30, 32 varies between cameras 12, 14, 16. It is nearly impossible to trigger frame capture for each of the cameras 12, 14, 16, at the exact same time rendering it also impossible that each sensor 34, 40, 44 is capable of generating an image starting at the exact same time. It is likely a substantial difference exists between the time frame actually captured and the time the image became available for any of the controllers 28, 30, 32 to process.

The invention of the present application overcomes these issues by time stamping each frame captured by the sensors 34, 40, 44 using the real-time clocks 22, 24, 26 that have been synchronized with the global time server 58 via the local time server 54. The time stamp is generated at the precise moment each camera controller 28, 30, 32 receives a first pixel in a frame from each sensor array 34, 40, 44, respectively. Continuous imaging that is synchronized between cameras 12, 14, 16 by the timestamp provides a unified method to synchronize the time of each frame capture across any number of cameras implemented in the inspection system 10.

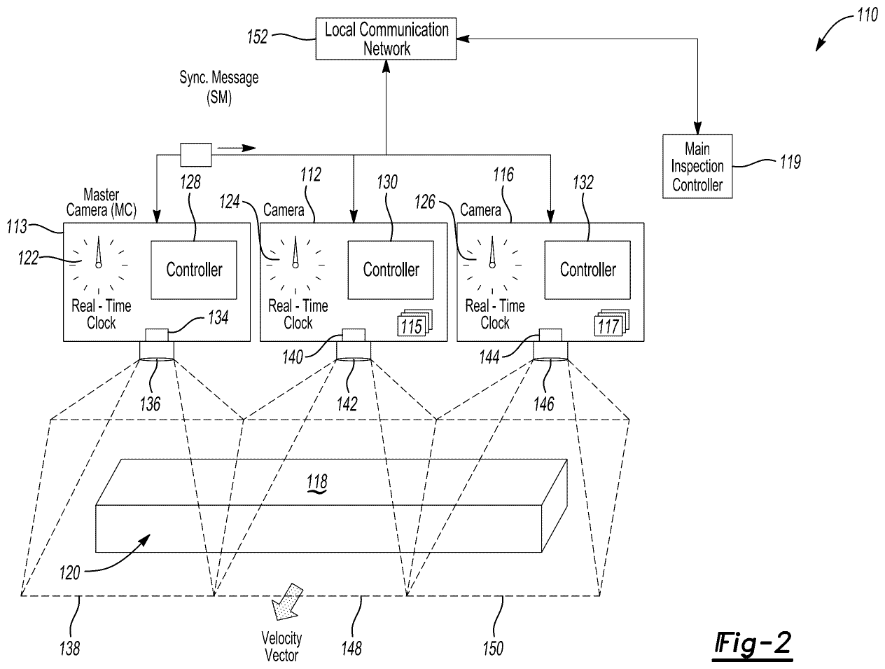

Synchronized inspection in the present application is also achievable for moving objects using a system represented in FIG. 2 generally at 110 where like elements include like element numbers of the prior embodiment in the 100 series and will not be further described herein. In this embodiment, a master camera 113 is implemented. The master camera 113 is configured to provide a time reference to each of the other cameras 114, 116. The master camera 113 captures a frame and time stamps the frame image using its own real time clock 122. Thus, the time stamped frame is stored locally in the first controller 128 that is integrated with the master camera 113. Concurrently, the second camera 114 and the third camera 116 are continuously capturing frames that are time stamped using each respective real time clock 124, 126. These frame images are locally stored in their respective controllers 130, 132.

The second camera 114 includes a second camera buffer 115 and the third camera 116 includes a third camera buffer 117. The master camera 113 does not include a buffer in this embodiment. Each buffer 115, 117 stores both the frame image pixels and related time stamps for each generated image. In a similar manner as set forth above, the time stamp is generated at the time the first pixel of each generated image is received at the related controller 130, 132. The size of each buffer 115, 117 is defined by using the rate at which frames are captured for each related camera 114, 116, the latency of each frame, i.e., the time between capture process starting in the time the frame becomes available for the controller 130, 132, and the sensor time difference between cameras 114, 116. The buffer is searchable using the timestamp generated by each real time clock 124, 126.

The frame generated by the master camera 113 is transferred to the master camera controller 128 for processing where it is time stamped by the master camera real time clock 122. The time stamp of the frame generated by the master camera 113 is shared with the other cameras 114, 116 by way of a synchronization message. The synchronization message is transferred to the other cameras 114, 116 using the local communication network 152. When the second camera 114 and the third camera 116, and more specifically the second camera controller 130 and the third camera controller 132 receive the synchronization message, the time stamp of the master camera 113 is used to search each buffer 115, 117 respectively seeking the closest match to the master controller frame. The frame contained in each buffer 115, 117 most closely matching the timestamp of the master controller frame is referred to as the closest match frame and includes the minimum time difference when compared to the timestamp of the master controller frame. The time difference between the master controller frame in the closest match frame is at a maximum ½ the time interval between frames, which is defined as the inverse of the camera frame rate. Higher frame rates mean shorter intervals and smaller time differences across each of the cameras 113, 114, 116. The closest match frame of each camera 114, 116 is sent to the camera controller 130, 132 respectively for processing. The result of using the real time clock 122, 124, 126, which is previously synchronized across cameras 113, 114, 116 respectively and the frame buffer allows processing frame images of each camera that are very close in time. Final analysis of the images of each FOV 138, 148, 150 is performed by a main inspection controller 119 via the local communication network 152.

When inspecting stationary objects, the process described above guarantees that all controllers cross each of the cameras 113, 114, 116 process images at the exact moment in time. However, a time difference between the master camera 113 image and the closest match frame (CM) of the integrated cameras 114, 116 may exist and is referred to synchronization time error (STE). It is possible that during STE that the object 120 could have moved. When accurate inspection is dependent upon position of the object relative to the cameras 113, 114, 116 compensation for the motion occurring during the STE is desirably compensated for. In this case, the system 110 estimates a velocity vector (VV) of the object 120.

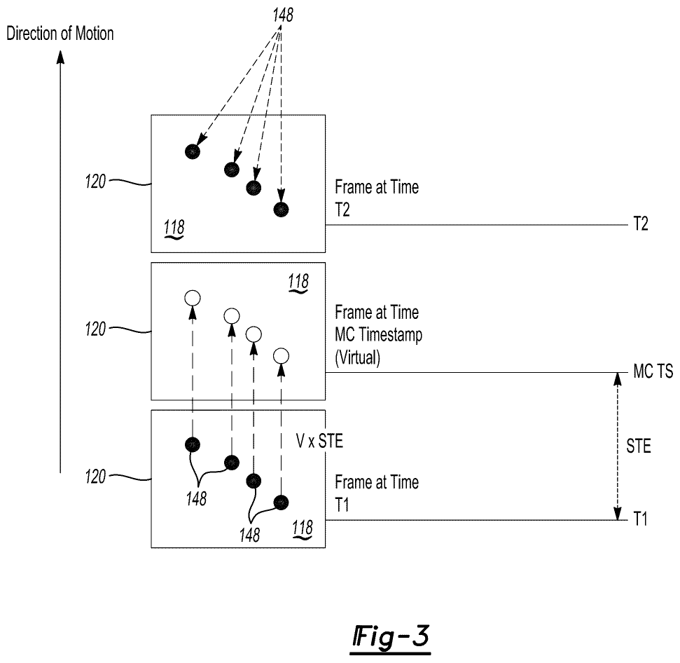

The velocity vector is calculated using image frames captured from the master camera 113, second and third cameras 114, 116 or other sensor-based devices via the camera lenses 136, 142, 146, respectively. As best represented in FIG. 3, the image frames at first time T1 and a second time T2 exist in a frame buffer 115, 117. The image frames include an object of interest 148 captured by the sensors 134, 140, 144 such as, for example, items disposed on the surface 118 of the object 120 being inspected including corners, apertures, and even defects, etc. The object of interest 148 appears in both image frames. By analyzing each frame, the position of each object of interest 148 relative to a selected reference frame can be calculated. When the master camera 113 transfers a synchronization message to each of the other cameras 114, 116 a target frame is selected. For example, the frame at T1 shown in FIG. 3 is selected. However, if it is determined the objects are moving during the STE, using the velocity of the object 120, and the STE, it can be estimated where the objects will be located in the image frame at T2. A velocity vector is calculated by the inspection controller 119 calculating direction and speed of movement of the object of interest 148 between image frame T1 and image frame T2. Thus, by using velocity vector, it can be calculated how much each object in the frame has moved during the STE period and even predict a next location of the object of interest 148 with a following image frame.

The invention has been described is in an illustrative manner; many modifications and variations of the present invention are possible in light of the above teachings. It is therefore to be understood that within the specification, the reference numerals are merely for convenience, and are not to be in any way limiting, and that the invention may be practiced otherwise than is specifically described. Therefore, the invention can be practiced otherwise than is specifically described within the scope of the stated claims following this first disclosed embodiment.

What is claimed is:

1. An inspection system, comprising:
an inspection controller;
a first camera and a second camera aligned to cooperatively examine a surface of an object;
said first camera defining a first field of view of the object and said second camera defining a second field of view of the object with said first field of view and said second field of view encompassing distinct areas of the surface of the object;
said first camera including a first clock and said second camera including a second clock;
said first camera generating a plurality of first images of said object defined by said first field of view and said second camera generating a plurality of second images of said object defined by said second field of view; and
said inspection controller being programed to synchronize one of the plurality of first images generated by said first camera with one of said plurality of second images generated by said second camera when a first time stamp assigned by said first clock to one of said plurality of first images matches a second time stamp assigned by said second clock to one of said plurality of second images.

2. The inspection system set forth in claim 1, wherein said first camera includes a first controller and said second camera includes a second controller, each of said first controller and said second controller being electronically integrated with said inspection controller.

3. The inspection system set forth in claim 2, wherein said inspection controller comprises a frame buffer buffering images generated by said first camera and said second camera, whereby the first images and the second images for matching frames imaged that include similar first time stamps and second time stamps.

4. The inspection system set forth in claim 1, wherein said inspection controller comprises a first camera controller and a second camera controller.

5. The inspection system set forth in claim 4, wherein said first camera controller includes a first image buffer for buffering a plurality of first images and said second camera controller comprises a second image buffer for buffering a plurality of second images.

6. The inspection system set forth in claim 5, wherein said first camera controller and said second camera controller match the first time stamp with the second time stamp for generating a composite view of the object from the first image and the second image when first and second time stamps match.

7. The inspection system set forth in claim 1, wherein said system controller is programmed to calculate velocity vector of the object being inspected when the object moves for determining amount of movement of the object during a synchronized time error period.

8. The inspection system set forth in claim 1, wherein said first camera and said second camera are electronically interconnected via a local communication network.

9. The inspection system set forth in claim 8, wherein said local communication network includes a local time server for synchronizing said first clock and said second clock.

10. The inspection system set forth in claim 9, wherein said local communication network is interconnected to a global time server via a global communication network for synchronizing said local timer server and said first and second clocks with a global time standard.

11. The inspection system set forth in claim 10, wherein said system controller is programmed to determine velocity and velocity vector of the object from sequential of synchronized first and second images when the object is subject to at least one of defined and dynamic movement.

12. A method of inspecting a surface of an object, comprising the steps of:
providing a first cameras system including a first clock and a second camera system including a second clock;
said first camera system generating a first plurality of images of the surface of the object and said second camera systems generating a second plurality of images of the surface of the object;
said first clock assigning a first time stamp to each of said first plurality of images and said second clock assigning a second time stamp to each of said second plurality of images; and
generating a composite image of the surface by synchronizing one of said first plurality of images with one of said second plurality of images by correlating one of said first time stamps with one of said second time stamps.

13. The method set forth in claim 12, further including a step of generating a buffer of at least one of said first plurality of images and said second plurality of images.

14. The method set forth in claim 13, further including a step of assigning a time stamp to each of the images retained in said buffer.

15. The method set forth in claim 12, further including a step of electronically interconnecting a local time server with said first clock and said second clock and synchronizing said first clock with said second clock with said local time server.

16. The method set forth in claim 12, wherein said step of generating a first plurality of images and a second plurality of images is further defined by said first plurality of images being of an area of the surface being distinct from the second plurality of images.

17. The method set forth in claim 12, where said first camera comprises a master camera and a first controller and said controller performs a search of the plurality of image generated by said second camera retained in a buffer of said second camera for matching the first time stamp with the second time stamp.

18. The method set forth in claim 12, further including a step of determining velocity of movement of the object from sequential time stamped images generated by either of said first camera and said second camera.

19. The method set forth in claim 12, further including a step of calculating a velocity vector of the object from sequential time stamped images generated by either of said first camera and said second camera.

20. The method set forth in claim 19, further including a step of predicting a next location of the object from the velocity vector.
